(19) United States
(12) Patent Application Publication
(10) Pub. No.: US 2025/0215710 A1
(43) Pub. Date: Jul. 3, 2025

(54) TOOL, COVER FOR TOOL, AND LOCKING BODY FOR TOOL

(71) Applicant: Max Co., Ltd., Tokyo (JP)

(72) Inventors: Kouichirou Morimura, Tokyo (JP); Terufumi Hamano, Tokyo (JP)

(21) Appl. No.: 18/984,161

(22) Filed: Dec. 17, 2024

(30) Foreign Application Priority Data
Dec. 28, 2023 (JP) 2023-223548

(51) Int. Cl. E04G 21/12; B25F 5/02

(52) U.S. Cl. CPC E04G 21/123; B25F 5/02

(57) ABSTRACT

A tool includes a main body part, a gripping part connected to the main body part, and a plurality of locking part each provided at different angles to point at a center of gravity of the tool and each configured to fix a to-be-engaged object. The locking parts are provided on the main body part.

### CROSS-REFERENCE TO RELATED APPLICATIONS

The present application claims priority from Japanese Patent Application No. 2023-223548 filed on Dec. 28, 2023, the entire contents of which are incorporated herein by reference.

### TECHNICAL FIELD

The present disclosure relates to a tool having a hook attached thereto, which can be hooked on a to-be-engaged object, and a cover having a hook attached thereto, which can be hooked on a to-be-engaged object, and configured to be attachable and detachable with respect to a tool.

### BACKGROUND ART

Some hand-held tools, such as a reinforcing bar binding machine, a nailing machine, a drilling machine, and a screw tightening machine, have a hook attached thereto that enables the tool to be hooked on a to-be-engaged object.

JP2023-41539A describes a binding machine including: a main body part including a binding unit for binding a wire provided on a front end portion in a longitudinal direction and accommodating a drive unit for driving the binding unit; an accommodation unit provided on a lower surface side of the main body part and accommodating the wire in a manner of capable of feeding the wire out; a gripping unit provided on the lower surface side of the main body part and behind the accommodation unit; a first hook attachment part located on an upper surface side of the main body part and capable of attaching a hook opened at one side;

and a second hook attachment part located on a side surface side of the main body part and capable of attaching a hook opened at one side, in which the hook is attached to the first hook attachment part such that an opening of the hook faces toward a front side in the longitudinal direction of the main body part, and the hook is attached to the second hook attachment part such that an opening of the hook faces toward a center of gravity of the binding machine.

### SUMMARY OF INVENTION

At a work site where a reinforcing bar arrangement work for arranging reinforcing bars on a wall, a pillar, or the like, and a binding work for binding the arranged reinforcing bars with a wire are performed, it may be advantageous, in terms of work efficiency when transitioning to a next binding work or the like, to hook a tool, such as a reinforcing bar binding machine that is not temporarily used, on the arranged reinforcing bar rather than placing the tool on the scaffold.

In the binding machine described in Patent Literature 1, the opening of the hook attached to the second hook attachment part faces toward the center of gravity of the binding machine. Thereby, in the case where the binding machine is hooked on the reinforcing bar using the hook, the orientation of the binding machine does not change significantly even when the hand is detached from the binding machine.

However, when a user of the binding machine hooks the binding machine on the reinforcing bar using the hook and then grips and uses the binding machine again, the way the tool is used varies depending on the user, making it necessary to accommodate various usage patterns of individual users.

The present disclosure has been made in view of the above problems, and an object thereof is to provide a tool having a hook attached thereto, which can be hooked on a to-be-engaged object, and a cover having a hook attached thereto, which can be hooked on a to-be-engaged object, and configured to be attachable and detachable with respect to a tool, in response to various usage patterns of individual users.

According to an aspect of the present disclosure, a tool includes a main body part, a gripping part connected to the main body part, and a plurality of locking part each provided at different angles to point at a center of gravity of the tool and each configured to fix a to-be-engaged object. In the tool, the locking parts are provided on the main body part.

According to another aspect of the disclosure, a cover is configured to be attachable to and detachable from a tool including a main body part and a gripping part connected to the main body part. The cover includes a plurality of locking part provided at different angles to point at a center of gravity of the tool and each configured to fix a to-be-engaged object, and the locking parts are provided on the cover.

According to another aspect of the disclosure, a locking body for a tool includes a main body part and a gripping part connected to the main body part. The locking body is configured to be attachable to a locking part provided on the main body to point at a center of gravity of the tool, and the locking part is configured to be engaged with a to-be-engaged object via the locking body. In another aspect, a locking body for a tool includes a main body part and a gripping part connected to the main body part. The locking body is configured to be attachable to a locking part provided on a cover configured to be attachable and detachable with respect to the tool to point at a center of gravity of the tool, and the locking part is configured to be engaged with a to-be-engaged object via the locking body.

In the present disclosure, the locking body that can be engaged with a to-be-engaged object is attached at different angles toward the center of gravity of the tool.

In the present disclosure, the locking body that can be hooked on a to-be-engaged object can be attached at different angles toward the center of gravity of the tool, in response to various usage patterns of individual users.

In addition, the cover of the present disclosure can be attached to an existing tool, and the locking body, which can be hooked on a to-be-engaged object, can be attached to an existing tool at different angles toward the center of gravity of the tool, in response to various usage patterns of individual users.

### BRIEF DESCRIPTION OF DRAWINGS

FIG. 1A is a side view showing an example of a reinforcing bar binding machine of the present embodiment, as seen from one side.

FIG. 1B is a perspective view showing the example of the reinforcing bar binding machine of the present embodiment, as seen from one side.

FIG. 2A is a side view showing the example of the reinforcing bar binding machine of the present embodiment, as seen from the other side.

FIG. 2B is a perspective view showing the example of the reinforcing bar binding machine of the present embodiment, as seen from the other side.

FIG. 3 is a perspective view showing an example of a hook.

FIG. 4 is a perspective view showing an example of a hook attachment part.

FIG. 5 is an exploded perspective view showing the example of the reinforcing bar binding machine of the present embodiment, with a cover exploded.

FIG. 6A is a perspective view showing an example of the cover.

FIG. 6B is a perspective view showing the example of the cover.

FIG. 6C is a perspective view showing the example of the cover.

FIG. 6D is a perspective view showing the example of the cover.

FIG. 7A is a side view showing the example of the reinforcing bar binding machine of the present embodiment, with no hook attached, as seen from one side.

FIG. 7B is a cross-sectional view taken along line A-A of FIG. 7A.

FIG. 8 is a perspective view of the reinforcing bar binding machine showing an example of a hook attachment method.

FIG. 9 is an internal configuration view showing an example of an overall configuration of the reinforcing bar binding machine of the present embodiment, as seen from a side.

FIG. 10A is an explanatory view showing an example of a hook usage form.

FIG. 10B is an explanatory view showing the example of the hook usage form.

FIG. 11A is a side view of the reinforcing bar binding machine showing an example of hook attachment.

FIG. 11B is a side view of the reinforcing bar binding machine showing an example of hook attachment.

FIG. 12A is a side view of the reinforcing bar binding machine showing an example of hook attachment.

FIG. 12B is a side view of the reinforcing bar binding machine showing an example of hook attachment.

FIG. 13 is a top view of the reinforcing bar binding machine showing an example of hook attachment.

FIG. 14A is an explanatory view showing another example of the hook usage form.

FIG. 14B is an explanatory view showing another example of the hook usage form.

FIG. 15 is an explanatory view showing another example of the hook.

### DESCRIPTION OF EMBODIMENTS

Hereinafter, an example of a reinforcing bar binding machine as an embodiment of a tool of the present disclosure and examples of a cover for a tool and a locking body for a tool, which are attached to the reinforcing bar binding machine, will be described with reference to the drawings.

### Configuration Example of Reinforcing Bar Binding Machine of Present Embodiment

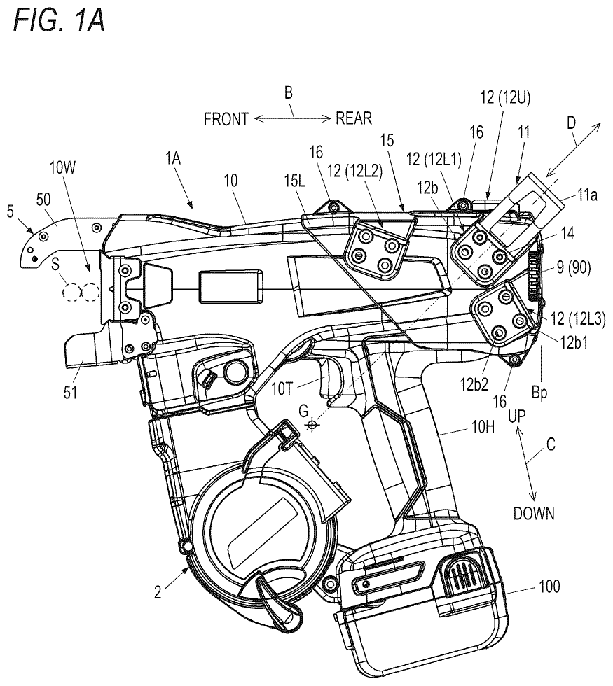

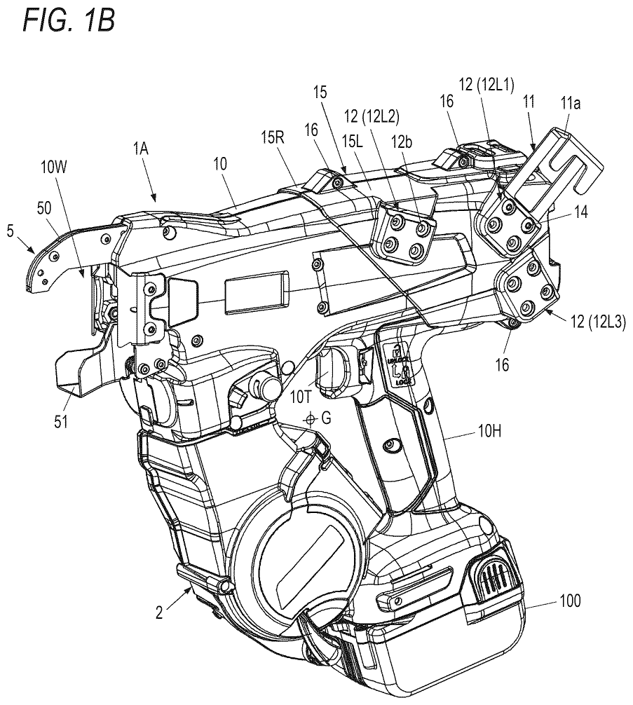

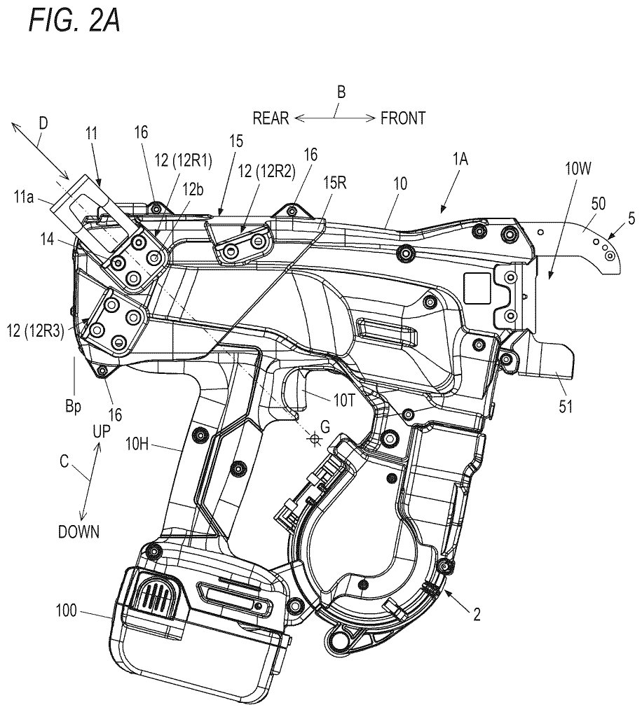

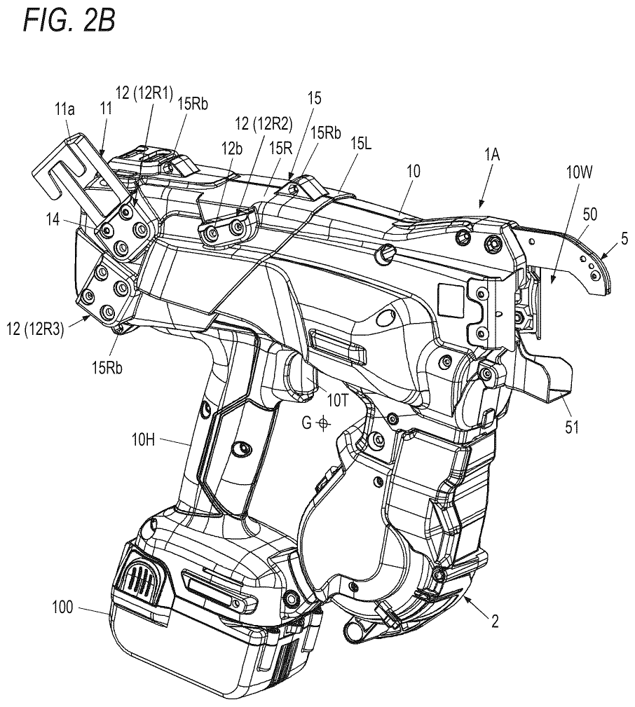

FIG. 1A is a side view showing an example of a reinforcing bar binding machine of the present embodiment, as seen from one side, and FIG. 1B is a perspective view showing the example of the reinforcing bar binding machine of the present embodiment, as seen from one side. In addition, FIG. 2A is a side view showing the example of the reinforcing bar binding machine of the present embodiment, as seen from the other side, and FIG. 2B is a perspective view showing the example of the reinforcing bar binding machine of the present embodiment, as seen from the other side.

A reinforcing bar binding machine 1A has such a shape that an operator grips with a hand, and includes a main body part 10 and a handle part 10H as an example of a gripping part connected to the main body part 10.

The reinforcing bar binding machine 1A forms a working section 10W on one side along an extension direction of the main body part 10 indicated by arrow B, where a work of binding a reinforcing bar S, which is a to-be-worked object, is performed. In the reinforcing bar binding machine 1A, with respect to the extension direction of the main body part 10, one side where the working section 10W is formed is referred to as a front side, and the other side opposite to the side where the working section 10W is formed is referred to as a rear side.

In addition, in the reinforcing bar binding machine 1A, the handle part 10H extends in a direction intersecting the extension direction of the main body part 10. That is, in the reinforcing bar binding machine 1A, the extension direction of the handle part 10H indicated by arrow C intersects the extension direction of the main body part 10. In the reinforcing bar binding machine 1A, a side on which the handle part 10H is formed is referred to as a lower side (one side), and a side opposite to the side on which the handle part 10H is formed is referred to as an upper side (other side).

The reinforcing bar binding machine 1A includes a locking part that can lock a to-be-engaged object, such as the reinforcing bar S. The locking part can lock the to-be-engaged object directly or indirectly. In the present embodiment, a form is shown in which the to-be-engaged object can be indirectly engaged. The locking part has a hook 11 attached thereto, which enables the reinforcing bar binding machine 1A to be hooked on the reinforcing bar S. The hook 11 is an example of a locking body and a locking body for a tool, and includes a locked portion 11a at an end portion of the hook 11 in an extension direction indicated by arrow D, which can lock to the reinforcing bar S.

The reinforcing bar binding machine 1A includes a plurality of hook attachment parts 12 provided at different angles toward a center of gravity G of the reinforcing bar binding machine 1A. The hook attachment part 12 is an example of the locking part, and enables the hook 11 to be attached at different angles toward the center of gravity G of the reinforcing bar binding machine 1A. In the above, “to be attached at different angles” refers to a structure where the locking body is attached and fixed to the locking part at predetermined angles. Additionally, “fixed” refers to a state that allows for some degree of relative displacement without affecting the locking.

The hook attachment part 12 is preferably provided on at least one side surface of a rear side of the main body part 10. The side surface referred to herein refers to a surface parallel to the extension direction of the main body part 10. Preferably, when the hook attachment part 12 is provided on a side surface of the main body part 10, that is, arranged at a position away from the handle part 10H, it is difficult for a worker's hand gripping the handle part 10H to come into contact with the reinforcing bar S as a to-be-engaged object. It is preferable that, in the hook attachment part 12 provided on a side surface of the main body part 10, the hook 11 is attached such that the locked portion 11a faces toward the center of gravity G of the reinforcing bar binding machine 1A when the reinforcing bar binding machine 1A is viewed from a side. In a configuration where a plurality of hook attachment parts 12 are provided, it is preferable that, in at least one hook attachment part 12, the hook 11 is attached such that the locked portion 11a faces toward the center of gravity G of the reinforcing bar binding machine 1A when the reinforcing bar binding machine 1A is viewed from a side.

It is preferable that in the hook attachment part 12, the hook 11 is attached in a direction in which the extension direction of the hook 11 intersects the extension direction of the handle part 10H. In the configuration where the plurality of hook attachment parts 12 are provided, it is preferable that, in at least one hook attachment part 12, the hook 11 is attached in a direction in which the extension direction of the hook 11 intersects the extension direction of the handle part 10H.

In addition, it is preferable that in the hook attachment part 12, the hook 11 is attached such that the locked portion 11a is positioned on a rear side in the extension direction with respect to an extension line of the handle part 10H in the extension direction. In addition, it is preferable that, in the hook attachment part 12, the hook 11 is attached such that at least a part of the locked portion 11a is positioned on a rear side with respect to a rear end Bp of the main body part 10. In the configuration where the plurality of hook attachment parts 12 are provided, it is preferable that, in at least one hook attachment part 12, the hook 11 is attached such that at least a part of the locked portion 11a is positioned on a rear side with respect to the rear end Bp of the main body part 10.

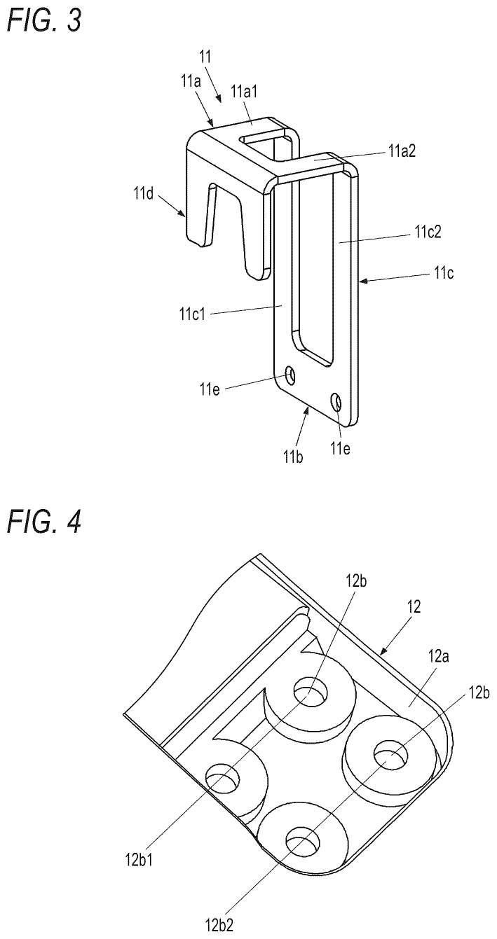

FIG. 3 is a perspective view showing an example of a hook. The hook 11 includes a supported portion 11b that can be fixedly supported on the hook attachment part 12, an extension portion 11c having a predetermined dimension connecting the supported portion 11b and the locked portion 11a, and a convex locked portion 11d that suppresses the hook 11 from falling off from a to-be-engaged object.

In the hook 11, the extension portion 11c extends from the supported portion 11b. The locked portion 11a is formed at the top of the extension portion 11c. The convex locked portion 11d extends from the locked portion 11a in a direction toward the supported portion 11b along the extension portion 11c. The hook 11 is opened between the convex locked portion 11d and the extension portion 11c to a dimension that allows for insertion of a to-be-engaged object, such as the reinforcing bar S.

In the present example, the extension portion 11c includes a first extension portion 11c1 and a second extension portion 11c2. The first extension portion 11c1 and the second extension portion 11c2 extend in parallel to each other. In addition, in the present example, the locked portion 11a includes a first locked portion 11a1 and a second locked portion 11a2. The first locked portion 11a1 connects to the first extension portion 11c1, and the second locked portion 11a2 connects to the second extension portion 11c2. In the hook 11, an orientation in which the first locked portion 11a1 and the second locked portion 11a2 are aligned is orthogonal to the extension direction of the hook 11. Note that the orientation in which the first locked portion 11a1 and the second locked portion 11a2 are aligned need not be orthogonal to the extension direction of the hook 11, as long as the to-be-engaged object can be engaged.

The supported portion 11b has a fastening portion 11e to which a screw 14 is fastened. The fastening portion 11e is an example of a fixing portion and, in the present example, is configured as an internal thread penetrating through the plate-shaped supported portion 11b. The hook 11 may have a plurality of fastening portions 11e to enable it to be fastened to the hook attachment part 12 with a plurality of screws 14. The supported portion 11b, in the present example, has two fastening portions 11e. Note that the support configuration, including the number and positions of fastening points and the support means (fastening), may be appropriately changed as long as the to-be-engaged object can be engaged.

FIG. 4 is a perspective view showing an example of a hook attachment part. The hook attachment part 12 includes a support portion 12a capable of supporting the supported portion 11b, and a hole portion 12b into which a screw 14 is inserted.

The support portion 12a has a predetermined shape conforming to an outer shape of the supported portion 11b and is configured with a recessed portion or the like into which the supported portion 11b can be inserted. Thereby, the support portion 12a is configured such that, when the supported portion 11b is inserted, an attachment position, an orientation, and the like of the hook 11 can be determined. In addition, when fixing the hook 11, the supported portion 11b is arranged in a state of being inserted into the support portion 12a, and the hole portion 12b1 and the fastening portion 11e can be fixed, so the hook 11 can be easily fixed to the hook attachment part 12 without the hook being significantly displaced from the fixed position. The orientation of the hook 11 refers to the orientation of the extension direction of the hook 11, that is, the orientation of the extension direction of the extension portion 11c.

The hole portion 12b is provided in the support portion 12a in alignment with the fastening portion 11e of the hook 11. The hook attachment part 12 may have a plurality of hole portions 12b to determine the orientation of the hook 11. In addition, the hook attachment part 12 may have a plurality of rows of hole portions 12b to allow the attachment position of the hook 11 to be variable. In the present example, the hook attachment part 12 is provided with two holes 12d aligned with the arrangement of the two fastening portions 11e and arranged in each of two rows at a predetermined spacing.

In the present example, the reinforcing bar binding machine 1A is provided with hook attachment parts 12L1, 12L2, and 12L3, and 12R1, 12R2, and 12R3 at three locations on the side surfaces of the main body part 10, respectively. In addition, the reinforcing bar binding machine 1A is provided with a hook attachment part 12U at one location on the upper surface of the main body part 10.

In the hook attachment parts 12L1, 12L2, 12L3, 12R1, 12R2, and 12R3, the shapes, orientations, and the like of the support portion 12a and the hole portion 12b are defined such that, when the hook 11 is attached, the locked portion 11a faces toward the center of gravity G of the reinforcing bar binding machine 1A, when the reinforcing bar binding machine 1A is viewed from a side.

Each hook attachment part 12 may be configured to be provided on a cover 15 that is attachable and detachable with respect to the reinforcing bar binding machine 1A.

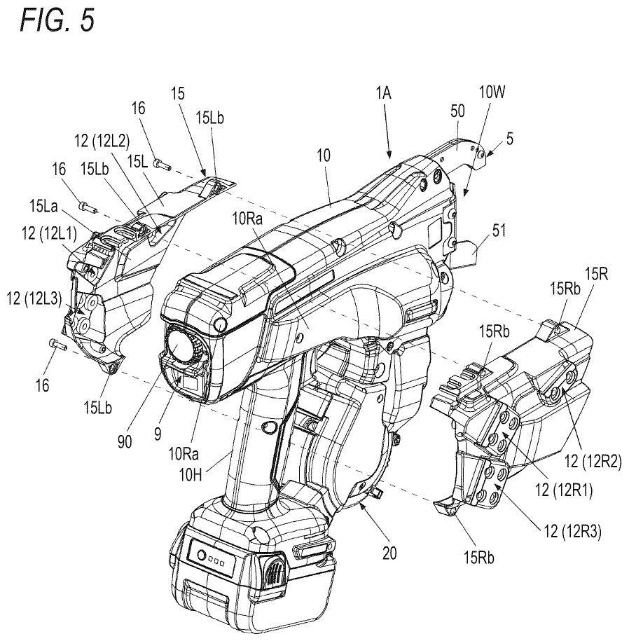

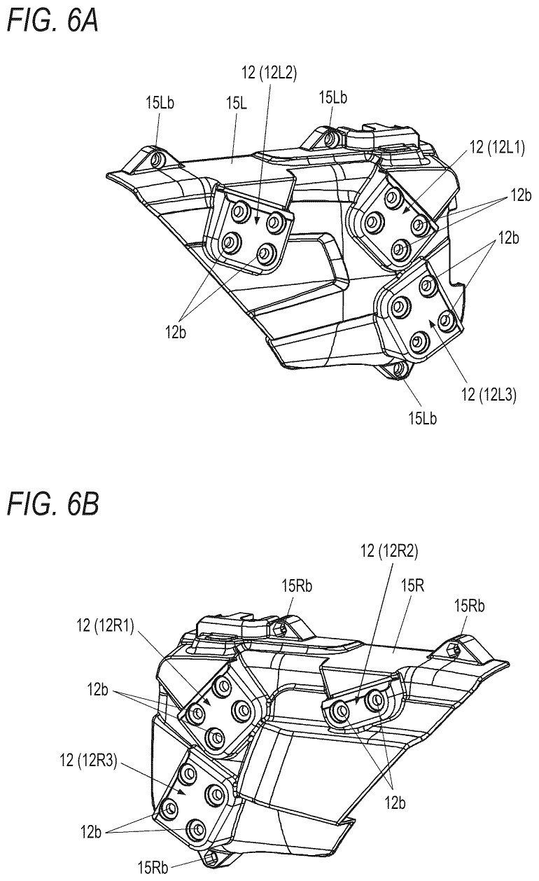

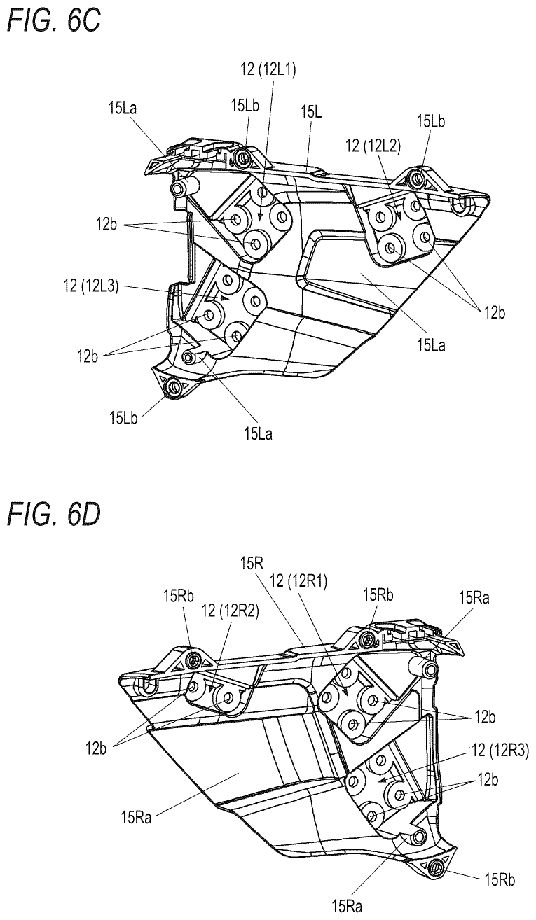

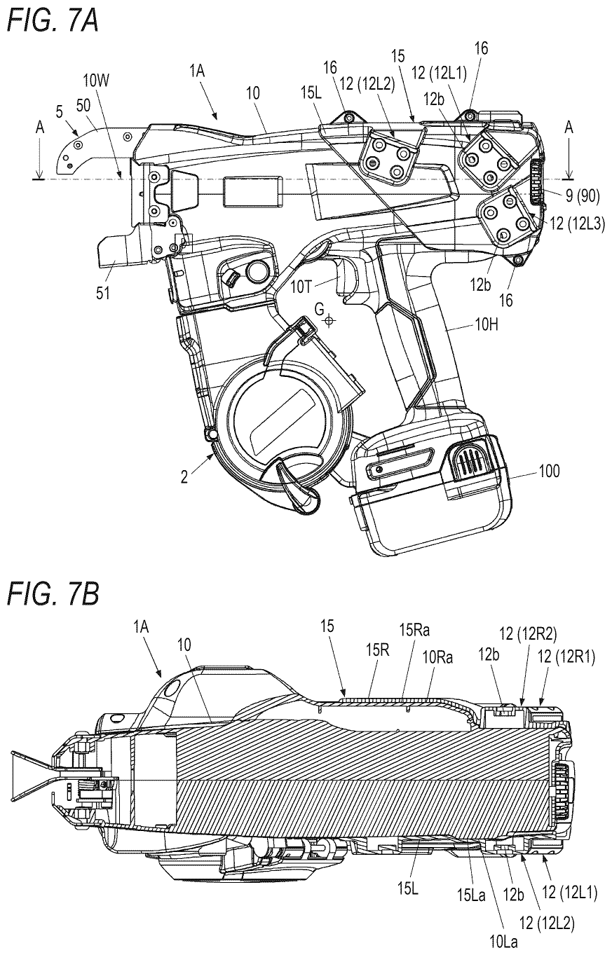

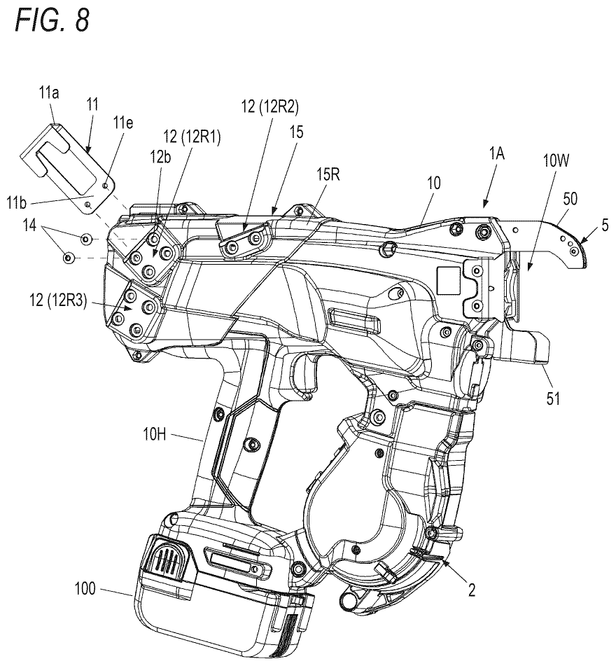

FIG. 5 is an exploded perspective view showing the example of the reinforcing bar binding machine of the present embodiment, with a cover exploded, and FIGS. 6A, 6B, 6C, and 6D are perspective views showing an example of the cover. In addition, FIG. 7A is a side view showing the example of the reinforcing bar binding machine of the present embodiment, with no hook attached, as seen from one side, and FIG. 7B is a cross-sectional view taken along line A-A of FIG. 7A. Additionally, FIG. 8 is a perspective view of the reinforcing bar binding machine showing an example of a hook attachment method.

The cover 15 is an example of a cover for a tool and includes a first cover part 15L and a second cover part 15R. The first cover part 15L is configured in a shape that covers one side surface on the rear side of the main body part 10, and the second cover part 15R is configured in a shape that covers the other side surface on the rear side of the main body part 10.

The first cover part 15L includes a positioning portion 15La on an inner surface facing one side surface of the main body part 10. In addition, the second cover part 15R includes a positioning portion 15Ra on an inner surface facing the other side surface of the main body part 10.

The main body part 10 has an unevenness in its outer shape due to a relationship of the internal configuration, a relationship in design, and a relationship such as provision of holes into which screws are inserted in order to integrate a plurality of members by screw fastening, and an unevenness portion 10La is formed on one side surface. Similarly, the main body part 10 has an unevenness portion 10Ra formed on the other side surface.

The positioning portion 15La is configured by providing an unevenness shape that matches the unevenness portion 10La on one side surface of the main body part 10. The positioning portion 15Ra is configured by providing an unevenness shape that matches the unevenness portion 10Ra on the other side surface of the main body part 10.

The first cover part 15L has a hole portion 15Lb into which a screw 16 is inserted. The second cover part 15R has a fastening portion 15Rb to which the screw 16 is fastened. The screw 16, the hole portion 15Lb, and the fastening portion 15Rb are examples of a connecting portion.

The first cover part 15L covers one side surface on the rear side of the main body part 10 with its position relative to the main body part 10 determined by aligning the positioning portion 15La with the unevenness portion 10La of the main body part 10. The first cover part 15R covers one side surface on the rear side of the main body part 10 with its position relative to the main body part 10 determined by aligning the positioning portion 15Ra with the unevenness portion 10Ra of the main body part 10.

The cover 15 covers one side surface of the reinforcing bar binding machine 1A with the first cover part 15L and the other side surface of the reinforcing bar binding machine 1A with the second cover part 15R, thereby aligning the positions of hole portion 15Lb and fastening portion 15Rb. The screw 16 inserted into the hole portion 15Lb is fastened to the fastening portion 15Rb, thereby integrating the first cover part 15L and the second cover part 15R and fixing the cover 15 to the reinforcing bar binding machine 1A.

In the cover 15, the positioning portion 15La of the first cover part 15L is fitted to the unevenness portion 10La of one side surface of the main body part 10, and the positioning portion 15Ra of the second cover part 15R is fitted to the unevenness portion 10Ra of the other side surface of the main body part 10. Thereby, the cover 15 is suppressed from unintentionally moving with respect to the reinforcing bar binding machine 1A and from unintentionally being uncovered from the reinforcing bar binding machine 1A.

In addition, in the cover 15, the first cover part 15L and the second cover part 15R are formed with the positioning portions 15La and 15Ra in conformity to the outer shape of the main body part 10 of the existing reinforcing bar binding machine 1A. Thereby, the existing reinforcing bar binding machine 1A that is not provided with the hook attachment part 12 can be provided with the hook attachment part 12 by using the cover 15.

In addition, the cover 15 covers the main body part 10 while leaving the handle part 10H exposed. Thereby, when gripping the handle part 10H, the cover 15 is suppressed from becoming an obstacle to gripping. Note that, in the present example, the reinforcing bar binding machine 1A includes an operation unit 9, which will be described below, provided at a rear end of the main body part 10. For this reason, the cover 15 has a shape with an opened rear end so that the operation unit 9 is exposed.

To attach the hook 11 to the hook attachment part 12, the supported portion 11b of the hook 11 is inserted into the support portion 12a. When the supported portion 11b is inserted into the support portion 12a, the orientation of the hook 11 with respect to the main body part 10 is determined by the shapes and the like of the support portion 12a and the supported portion 11b.

In addition, the hook 11 is fixed to the hook attachment part 12 with its orientation with respect to the main body part 10 determined by aligning the position of the fastening portion 11e with the hole portion 12b and fastening the screw 14 inserted into the hole portion 12b to the fastening portion 11e.

In addition, the position of the fastening portion 11a along the extension direction of the hook 11 is switched by aligning the position of the fastening portion 11e with the hole portions 12b1 of the first row or the hole portions 12b2 of the second row, and fastening the screw 14 inserted into the hole portion 12b to the fastening portion 11e.

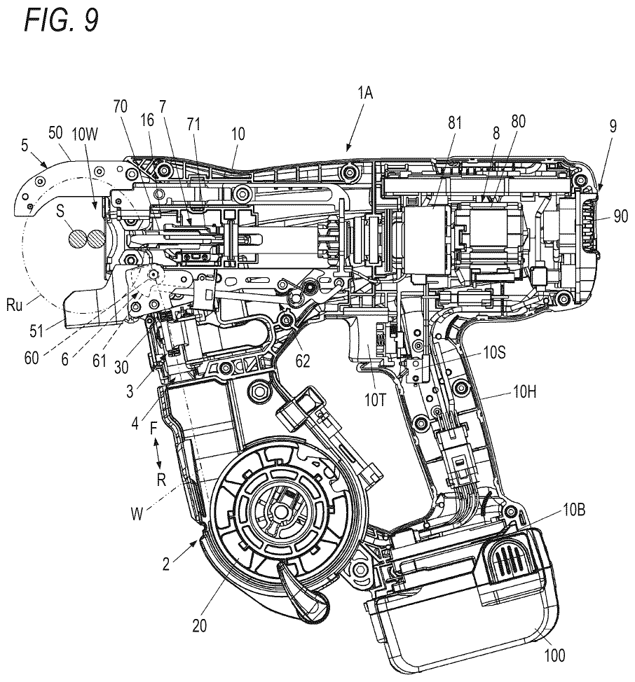

FIG. 9 is an internal configuration view showing an example of an overall configuration of the reinforcing bar binding machine of the present embodiment, as seen from a side. The reinforcing bar binding machine 1A feeds wires W in a forward direction indicated by arrow F, winds the wires around reinforcing bars S, which are a to-be-bound object, feeds the wires W wound around the reinforcing bars S in a reverse direction indicated by arrow R, winds the wires on the reinforcing bars S, and twists the wires W, thereby binding the reinforcing bars S with the wires W. The reinforcing bar binding machine 1A binds the reinforcing bars S with a plurality of wires W, in the present example, two wires W. Note that the reinforcing bar binding machine 1A may also be configured to bind the reinforcing bars S with one wire W.

In order to implement the above-described functions, the reinforcing bar binding machine 1A includes a magazine 2 in which the wires W are accommodated, a wire feeding unit 3 that feeds the wires W, and a wire guide 4 that guides the wires W, which are fed by the wire feeding unit 3. In addition, the reinforcing bar binding machine 1A includes a curl forming unit 5 that forms an annular feeding path for winding the wires W, which are fed by the wire feeding unit 3, around the reinforcing bars S, and a cutting unit 6 that cuts the wires W wound on the reinforcing bars S. In addition, the reinforcing bar binding machine 1A includes a binding unit 7 that twists the wires W wound on the reinforcing bars S, and a drive unit 8A that drives the binding unit 7. In addition, the reinforcing bar binding machine 1A includes an operation unit 9 that can set a magnitude of a binding force for twisting and binding the wires W, and the like.

The magazine 2 is an example of an accommodation unit, and a reel 20 on which the long wires W are wound to be reeled out is rotatably and detachably accommodated therein. The wire W is an example of a consumable item. For the wire W, a wire made of a plastically deformable metal wire, a wire having a metal wire covered with a resin, or a twisted wire is used. In a configuration in which the reinforcing bars S are bound with two wires W, the two wires W are wound on the reel 20 and can be pulled out at the same time from the reel 20.

The wire feeding unit 3 includes a pair of feeding gears 30 that sandwiches and feeds the wires W. In the wire feeding unit 3, a rotating operation of a feeding motor (not shown) is transmitted to the feeding gears 30, causing the feeding gears 30 to rotate.

Additionally, in the wire feeding unit 3, a rotation direction of the feeding motor (not shown) is switched between forward and reverse directions to switch a rotation direction of the feeding gears 30, thereby switching a feeding direction of the wires W between the forward and reverse directions. In the configuration where the reinforcing bars S are bound with two wires W, the wire feeding unit 3 aligns the two wires W in a radial direction of the wires W and feeds the wires.

The wire guide 4 is arranged on an upstream side and a downstream side (not shown) of the feeding gears 30 with respect to the feeding direction of the wires W that are fed in the forward direction. In the configuration where the reinforcing bars S are bound with two wires W, the wire guide 4 aligns the two entering wires W in parallel along a direction in which the pair of feeding gears 30 is aligned and guides the same between the pair of feeding gears 30.

The curl forming unit 5 includes a curl guide 50 that curls the wire W fed by the wire feeding part 3, and an induction guide 51 that guides the wire W curled by the curl guide 50 toward the binding part 7. The curl forming unit 5 curls the wires W, which are fed by the wire feeding unit 3 and pass through the curl guide 50, thereby forming an annular feeding path Ru, represented by a two-dot chain line, passing through the induction guide 51 from the curl guide 50 and reaching the binding unit 7.

The cutting unit 6 includes a fixed blade part 60, a movable blade part 61 that cuts the wires W in cooperation with the fixed blade part 60, and a transmission mechanism 62 that transmits an operation of the binding unit 7 to the movable blade part 61. The cutting unit 6 cuts the wires W by a rotating operation of the movable blade part 61 about the fixed blade part 60 as a fulcrum shaft.

The binding unit 7 includes a wire locking body 70 to which the wires W are engaged, and a sleeve 71 for actuating the wire locking body 70. The drive unit 8 includes a twist motor 80 and a decelerator 81 that performs deceleration and torque amplification.

In the reinforcing bar binding machine 1A, the curl guide 50 and the induction guide 51 of the curl forming unit 5 are provided at an end portion on a front side of the main body part 10. The curl forming unit 5 constitutes a working section 10W.

In the reinforcing bar binding machine 1A, a trigger 10T is provided on a front side of the handle part 10H, and a switch 10S is provided inside the handle part 10H. In the reinforcing bar binding machine 1A, a control unit (not shown) controls the feeding motor and the twist motor 80, in response to a state of the switch 10S that is pressed by an operation on the trigger 10T.

The reinforcing bar binding machine 1A includes a battery attachment unit 10B at a lower portion of the handle part 10H. The battery attachment unit 10B has a battery 100 detachably mounted.

In the reinforcing bar binding machine 1A, the magazine 2 is provided in front of the handle part 10H. In addition, in the reinforcing bar binding machine 1A, the wire feeding unit 3, the cutting unit 6, the binding unit 7, the drive unit 8 that drives the binding unit 7, and the like are accommodated in the main body part 10. The twist motor 80 is accommodated on a rear end side in the main body part 10.

The operation unit 9 includes an operating dial 90 and the like. The operation unit 9 is provided at the rear end of the main body part 10.

The center of gravity G of the reinforcing bar binding machine 1A is the center of gravity in an equipped state where the reel 20 with the wires W wound thereon is accommodated in the magazine 2 and the battery 100 is mounted to the battery attachment unit 10B, taking into account the use of the reinforcing bar binding machine 1A. The center of gravity G shown in FIG. 1A and the like is a position of the center of gravity in a state where the reel 20, on which a predetermined amount of wires W is wound, is accommodated in the magazine 2. In the reinforcing bar binding machine 1A, the wire W is consumed during an operation of binding the reinforcing bar S, and thus the amount of the wire W wound on the reel 20 decreases. Therefore, although a weight of the reel 20 changes, the center of gravity G of the reinforcing bar binding machine 1A is located approximately between the handle part 10H and the magazine 2.

### Example of Hook Usage Form

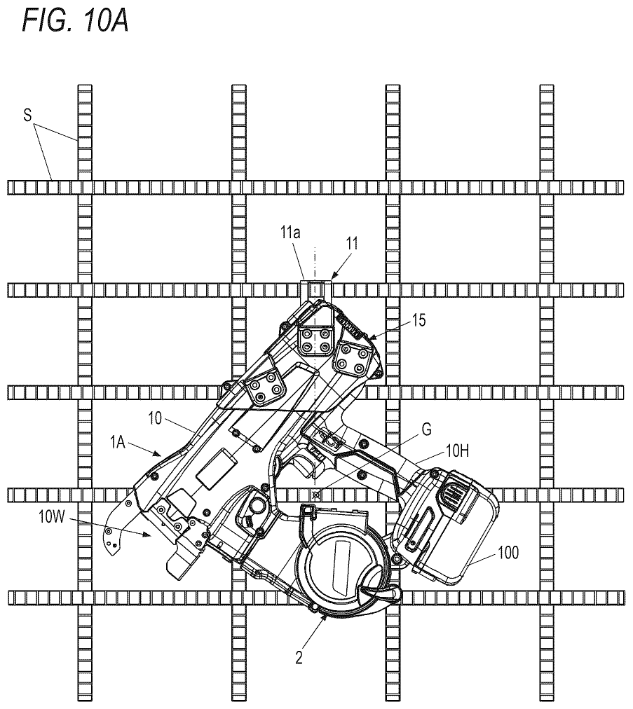

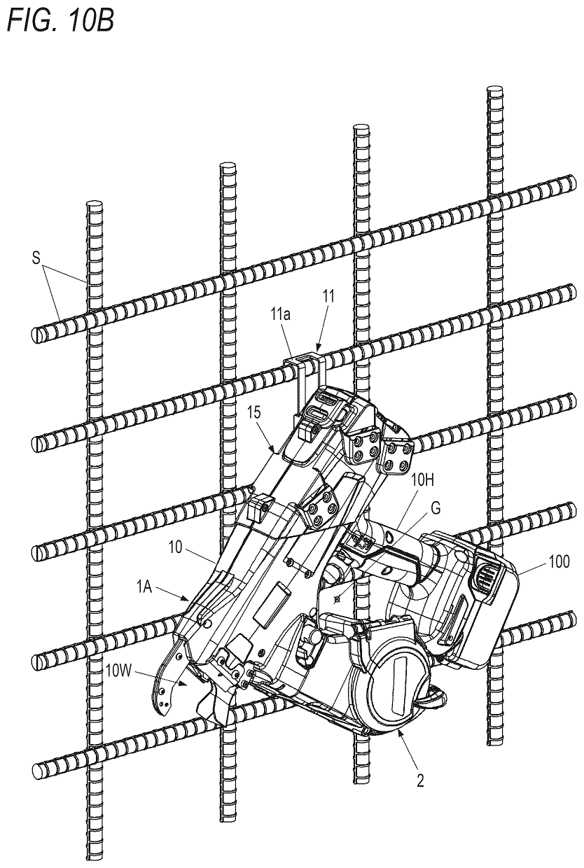

FIGS. 10A and 10B are explanatory views showing an example of a hook usage form. As shown in FIGS. 2A and 2B, when the hook 11 is attached to the hook attachment part 12R1, the extension direction of the hook 11 intersects the extension direction of the handle part 10H, and the locked portion 11a is positioned on a rear side with respect to the extension line of the extension direction of the handle part 10H and on a rear side with respect to the rear end Bp of the main body part 10. In addition, when the reinforcing bar binding machine 1A is viewed from a side, the locked portion 11a faces toward the center of gravity G of the reinforcing bar binding machine 1A.

An operation of hooking the reinforcing bar binding machine 1A on the reinforcing bar S using the hook 11 is considered when the arrangement surface of the reinforcing bars S is vertical.

The reinforcing bar binding machine 1A is used in such a form that the handle part 10H is gripped with the hand and the trigger 10T is operated with a finger of the hand gripping the handle part 10H. For this reason, the user of the reinforcing bar binding machine 1A assumes a state in which the user extends the arm from the rear side of the main body part 10 and grips the handle part 10H.

When the user grips the handle part 10H with the right hand, in the operation of hooking the hook 11 on the transversely extending reinforcing bar S, the user sees the reinforcing bar binding machine 1A from the left side shown in FIG. 10A and the like. When the hook 11 is attached to the hook attachment part 12R1, the hook 11 is attached to a side surface opposite to a visible side surface of the main body part 10. However, since the locked portion 11a is positioned on the rear side with respect to the rear end Bp of the main body part 10, the user can see the locked portion 11a with the eyes even when looking at the reinforcing bar binding part 1A from the left side shown in FIG. 10A and the like. Thereby, it is possible to easily and reliably align the locked portion 11a with the position of the reinforcing bar S.

In addition, since the extension direction of the hook 11 intersects the extension direction of the handle part 10H, the user can hook the hook 11 on the reinforcing bar S without significantly changing the orientation of the wrist.

In addition, since the locked portion 11a faces toward the center of gravity G of the reinforcing bar binding machine 1A, when the hook 11 is hooked on the reinforcing bar S and the hand is detached from the handle part 10H, the orientation of the reinforcing bar binding machine 1A does not change significantly. Thereby, the reinforcing bar binding machine 1A can be reliably hooked on the reinforcing bar S using the hook 11. In addition, when gripping the handle part 10H again, there is no need to change the orientation of the wrist significantly. As a result, it is possible to accommodate various usage patterns of individual users.

The hook 11 is fixed to the hook attachment part 12 by the screw 14, which is another fixing portion, in a state in which its orientation with respect to the main body part 10 is determined by the shapes and the like of the support portion 12a and the supported portion 11b. The hook 11 is fixed to the hook attachment part 12 by at least two fixing portions in this way, thereby suppressing unintentional changes in orientation and the like.

Note that the cover 15 is made of resin, and the hook 11 is made of metal.

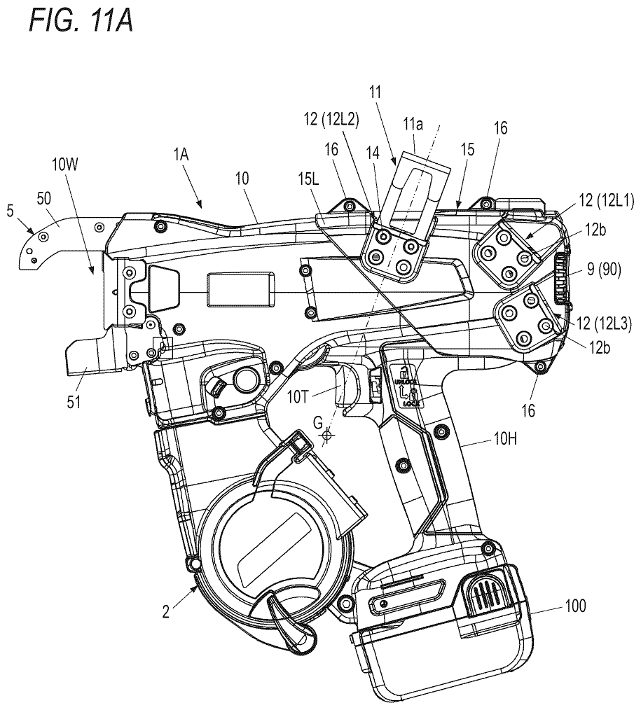

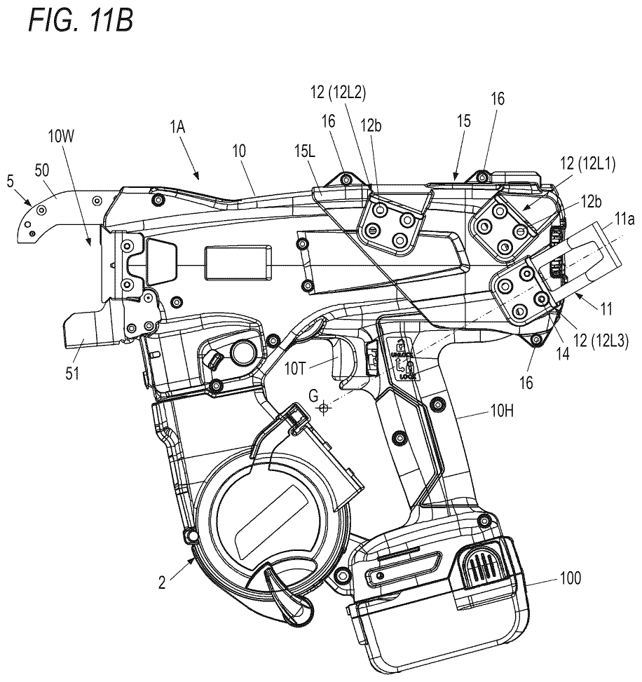

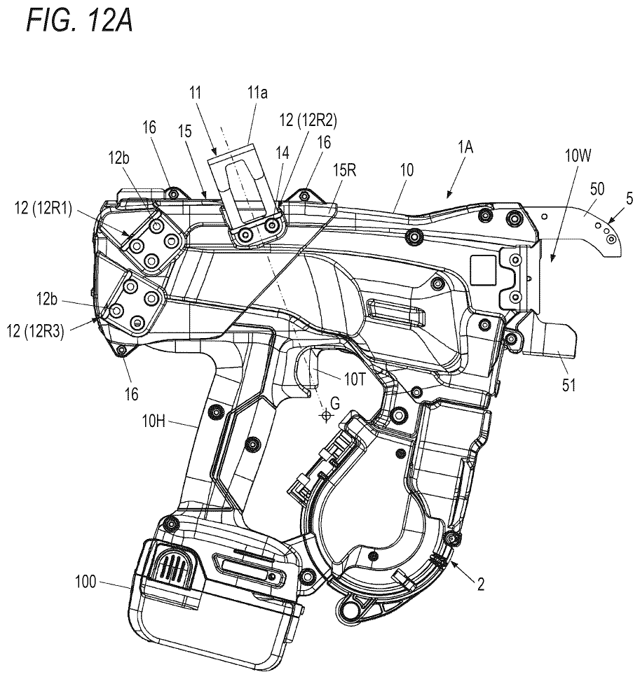

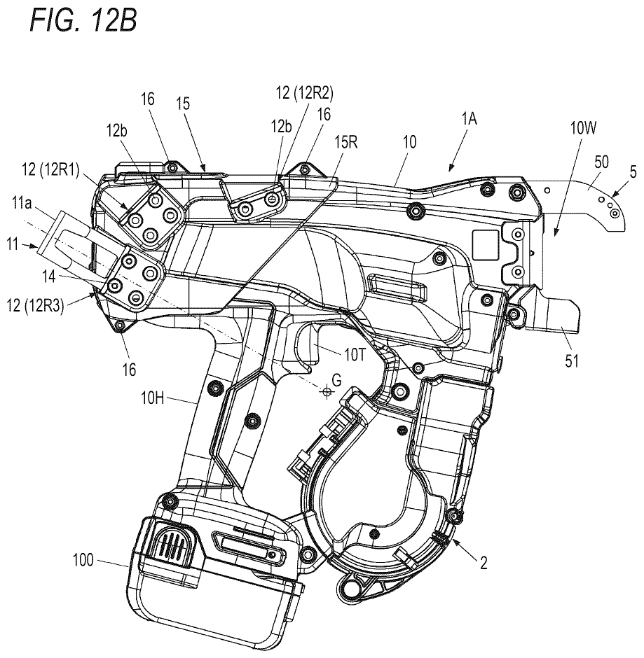

FIGS. 11A, 11B, 12A, and 12B are side views of the reinforcing bar binding machine showing examples of hook attachment, in which FIGS. 11A and 11B are side views of the reinforcing bar binding machine 1A as seen from one side, and FIGS. 12A and 12B are side views of the reinforcing bar binding machine 1A as seen from the other side.

In FIG. 11A, the hook 11 is attached to the hook attachment part 12L2. The hook 11

attached to the hook attachment part 12L2 is attached to the main body part 10 via the cover 15 at a different angle toward the center of gravity G of the reinforcing bar binding machine 1A when the reinforcing bar binding machine 1A is viewed from a side, with respect to the hook 11 attached to the hook attachment part 12L1. In the hook 11 attached to the hook attachment part 12L2, the locked portion 11a faces toward the center of gravity G when the reinforcing bar binding machine 1A is viewed from a side.

In FIG. 11B, the hook 11 is attached to the hook attachment part 12L3. The hook 11 attached to the hook attachment part 12L3 is attached to the main body part 10 via the cover 15 at a different angle toward the center of gravity G of the reinforcing bar binding machine 1A when the reinforcing bar binding machine 1A is viewed from a side, with respect to the hook 11 attached to the hook attachment part 12L1 and the hook 11 attached to the hook attachment part 12L2. In the hook 11 attached to the hook attachment part 12L3, the locked portion 11a faces toward the center of gravity G when the reinforcing bar binding machine 1A is viewed from a side.

In FIG. 12A, the hook 11 is attached to the hook attachment part 12R2. The hook 11 attached to the hook attachment part 12R2 is attached to the main body part 10 via the cover 15 at a different angle toward the center of gravity G of the reinforcing bar binding machine 1A when the reinforcing bar binding machine 1A is viewed from a side, with respect to the hook 11 attached to the hook attachment part 12R1. In the hook 11 attached to the hook attachment part 12R2, the locked portion 11a faces toward the center of gravity G when the reinforcing bar binding machine 1A is viewed from a side.

In FIG. 12B, the hook 11 is attached to the hook attachment part 12R3. The hook 11 attached to the hook attachment part 12R3 is attached to the main body part 10 via the cover 15 at a different angle toward the center of gravity G of the reinforcing bar binding machine 1A when the reinforcing bar binding machine 1A is viewed from a side, with respect to the hook 11 attached to the hook attachment part 12R1 and the hook 11 attached to the hook attachment part 12R2. In the hook 11 attached to the hook attachment part 12R3, the locked portion 11a faces toward the center of gravity G when the reinforcing bar binding machine 1A is viewed from a side.

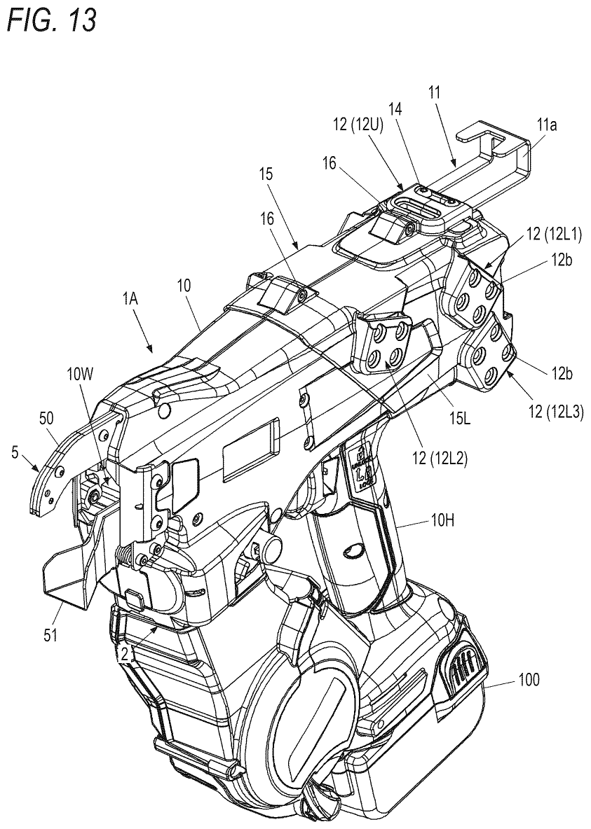

FIG. 13 is a top view of the reinforcing bar binding machine showing an example of hook attachment. In FIG. 13, the hook 11 is attached to the hook attachment part 12U. The hook 11 attached to the hook attachment part 12U is attached to the main body part 10 via the cover 15 at a different angle toward the center of gravity G of the reinforcing bar binding machine 1A with respect to the hook 11 attached to the other hook attachment parts 12.

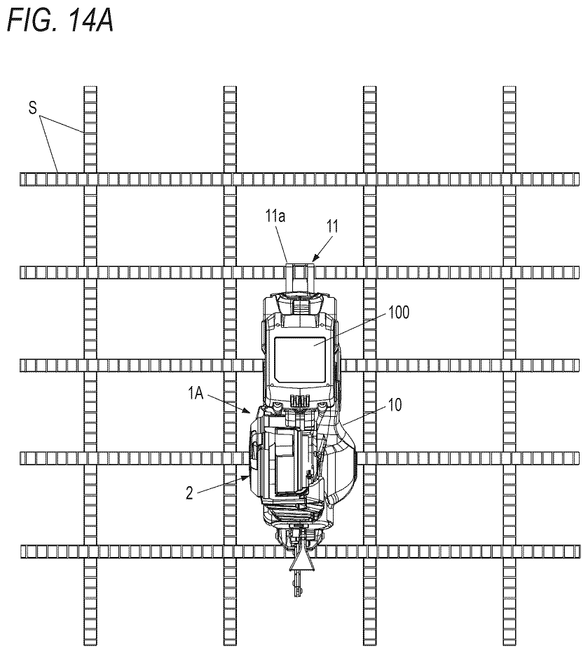

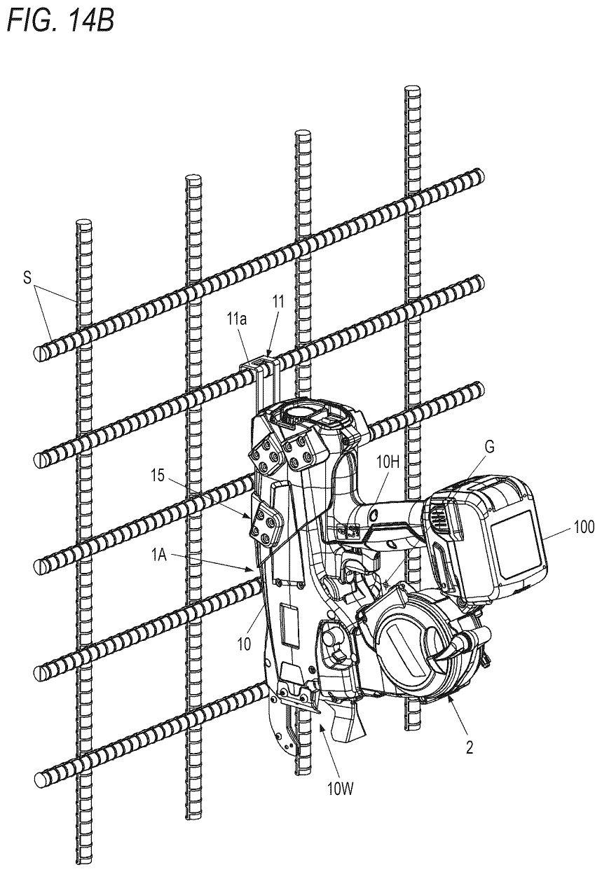

FIGS. 14A and 14B are explanatory views showing another example of the hook usage form. As shown in FIG. 13, when the hook 11 is attached to the hook attachment part 12U, the locked portion 10a does not point at the center of gravity G of the reinforcing bar binding machine 1A. However, when the hook 11 attached to the hook attachment part 12U is hooked on the reinforcing bar S, the upper surface of the main body part 10 comes into contact with the reinforcing bar S, and even when the hand is detached from the handle part 10H, the orientation of the reinforcing bar binding machine 1A does not change significantly. At this time, the handle part 10H extends in a direction intersecting the arrangement surface of the reinforcing bar S. As a result, it is possible to accommodate various usage patterns of individual users.

Note that although the plurality of hook attachment parts 12 have been described as having a configuration in which each hook attachment part is formed with the hole portions 12b, the hole portions 12b may be arranged so that they are commonly usable across the plurality of hook attachment parts 12.

### Another Configuration Example of Reinforcing Bar Binding Machine of Present Embodiment

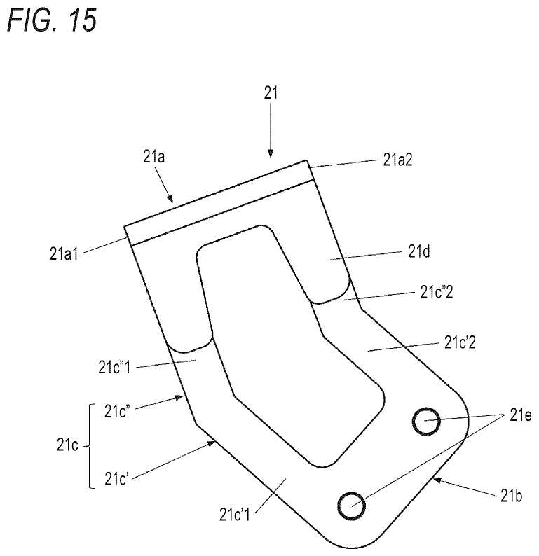

FIG. 15 is a view showing another example of the hook, which is a locking body. The hook 21 includes a supported portion 21b that can be supported on the hook attachment part 12, an extension portion 21c having a predetermined dimension connecting the supported portion 21b and the locked portion 21a, and a convex locked portion 21d that suppresses the hook 21 from falling off from a to-be-engaged object. Note that the locked portion 21a is a portion extending in the front-rear direction of the paper surface and has the same shape as shown in FIG. 3.

In hook 21, the extension portion 21c extends from the supported portion 21b. The locked portion 21a is formed at the top of the extension portion 21c. The convex locked portion 21d extends from the locked portion 21a in a direction toward the supported portion 21b along the extension portion 21c. The hook 21 is opened between the convex locked portion 21d and the extension portion 21c to a dimension that allows for insertion of a to-be-engaged object, such as the reinforcing bar S.

The extension portion 21c has a plurality of directional portions, and in the present example, from the supported portion 21b toward the locked portion 21a, has a first directional portion 21c′ and a second directional portion 21c″ whose extension direction is different from that of the first directional portion 21c′. As for the first directional portion 21c′ and the second directional portion 21c″, the first directional portion 21c′ has a first extension portion 21c′1 and a second extension portion 21c′2 having predetermined dimensions, and the second directional portion 21c″ has a first extension portion 21c″1 and a second extension portion 21c″2 having predetermined dimensions. The first extension portions 21c′1 and 21c″1 and the second extension portions 21c′2 and 21c″2 extend in parallel to each other, respectively. In addition, in the present example, the locked portion 21a includes a first locked portion 21a1 and a second locked portion 21a2. The first locked portion 21a1 connects to the first extension portion 21c″1 of the second directional portion, and the second locked portion 21a2 connects to the second extension portion 21c″2 of the second directional portion. In the hook 21, an orientation in which the first locked portion 21a1 and the second locked portion 21a2 are aligned is orthogonal to the extension direction of the second directional portion 21c″. Note that the orientation in which the first locked portion 21a1 and the second locked portion 21a2 are aligned and the extension direction of the second directional portion 21c″ need not be orthogonal as long as a to-be-engaged object can be engaged. In addition, although the extension portion has been described as having the two directional portions, the first directional portion and the second directional portion having different extension directions, the extension portion may have three or more directional portions having different extension directions. Further, the dimensions of the respective directional portions in their respective extension directions may be different, and the dimensions of the extension portions in the directions orthogonal to the extension directions of the respective directional portions may be the same or different.

The supported portion 21b has a fastening portion 21e to which a screw 14 is fastened. The fastening portion 21e is an example of a fixing portion and, in the present example, is configured as an internal thread penetrating through the plate-shaped supported portion 21b. The hook 21 may have a plurality of fastening portions 21e to enable it to be fastened to the hook attachment part 12 with a plurality of screws 14. The supported portion 21b, in the present example, has two fastening portions 21e. Note that the support configuration, including the number and positions of fastening points and the support means (fastening), may be appropriately changed as long as the to-be-engaged object can be locked.

In addition, the locking part need not be a hook attachment part, and the main body part 10 or the cover 15 may be provided with a shape capable of locking with a to-be-engaged object without using a hook.

In addition, the tool is not limited to the reinforcing bar binding machine. For example, a tool such as an electric drill driver is not equipped with a consumable item, and the center of gravity of the tool is determined in accordance with the equipment for a power supply source such as a battery. In addition, in a tool that uses compressed air as a power source to strike out a fastener such as a nail, the compressed air is supplied from an external air compressor, so the tool is not equipped with a power supply source, and the center of gravity of the tool is determined in accordance with the equipment for the fastener, which is a consumable item.

What is claimed is:

1. A tool comprising:
a main body part;
a gripping part connected to the main body part; and
a plurality of locking part each provided at different angles to point at a center of gravity of the tool and each configured to fix a to-be-engaged object, wherein
the locking parts are provided on the main body part.

2. The tool according to claim 1, wherein the main body part has a working section at a front end in an extension direction and configured to perform a work on a to-be-worked object,
the gripping part is provided on one side in a direction intersecting the extension direction, and
the locking parts are positioned on the other side in the direction intersecting the extension direction with respect to the gripping part.

3. The tool according to claim 1, wherein the main body part has a working section at a front end in an extension direction configured to perform a word on a to-be-worked object, and
the locking part are positioned behind the working section in an extension direction.

4. The tool according to claim 3, wherein the locking parts are configured to be lockable with a to-be-engaged object via a locking body, and
the locking body is configured to be attachable to one of the locking parts to point at the center of gravity.

5. The tool according to claim 4, wherein the main body part is provided with two of the locking parts whose positional relation is parallel to the extension direction and each of which is distant from the gripping part.

6. The tool according to claim 4, wherein the locking body includes a locked portion configured to lock to the to-be-engaged object, and
the locked portion protrudes further in the extension direction than the main body part in a state where the locking portion is attached to one of the locking parts.

7. The tool according to claim 1, wherein the locking part includes a plurality of fixing portions.

8. The tool according to claim 1, wherein the main body part includes
a binding unit configured to bind a reinforcing bar with a wire,
a battery attachment unit configured to attach a battery thereto, and
an accommodation unit configured to accommodate the wire.

9. A cover configured to be attachable to and detachable from a tool including a main body part and a gripping part connected to the main body part, the cover comprising:
a plurality of locking part provided at different angles to point at a center of gravity of the tool and each configured to fix a to-be-engaged object, wherein
the locking parts are provided on the cover.

10. The cover according to claim 9, wherein the main body part has a working section at a front end in an extension direction,
the gripping part is provided on one side of the main body in a direction intersecting the extension direction, and
the locking parts are positioned on the other side in the direction intersecting the extension direction with respect to the gripping part.

11. The cover according to claim 9, wherein the main body part has a working section at a front end in an extension direction, and
the locking parts are positioned behind the working section in an extension direction.

12. The cover according to claim 11, wherein the locking parts are configured to be lockable with a to-be-engaged object via a locking body, and
the locking body is configured to be attachable to one of the locking parts to point at the center of gravity.

13. The cover according to claim 12, wherein the main body part is provided with two of the locking parts whose positional relation is parallel to the extension direction and each of which is distant from the gripping part.

14. The cover according to claim 12, wherein the locking body includes a locked portion configured to lock to the to-be-engaged object, and
the locked portion protrudes further in the extension direction than the main body part in a state where the locking portion is attached to one of the locking parts.

15. The cover according to claim 9, wherein the locking part includes a plurality of fixing portions.

16. The cover according to claim 9, comprising a positioning portion conforming to an outer shape of the main body part, wherein
in a state where the cover is attached to attached to the main body part, the positioning portion is fitted to the main body part.

17. The cover according to claim 16, comprising:
a plurality of cover parts, and
a connecting portion configured to integrate the plurality of cover parts attached to the main body part.

18. The cover according to claim 17, wherein
the main body part has a working section at a front end in an extension direction of the tool,
the gripping part is provided on one side in a direction crossing the extension direction, and
the cover has a shape that is attached to the main body part while leaving the gripping part exposed.

19. The cover according to claim 9, wherein the tool includes
a binding unit configured to bind a reinforcing bar with a wire,
a battery attachment unit configured to attach a battery thereto, and
an accommodation unit configured to accommodate the wire.

20. A locking body for a tool, the tool including a main body part and a gripping part connected to the main body part, wherein the locking body is configured to be attachable to a locking part provided on the main body to point at a center of gravity of the tool, and the locking part is configured to be engaged with a to-be-engaged object via the locking body.
